(19) United States
(12) Patent Application Publication
(10) Pub. No.: US 2024/0401288 A1
(43) Pub. Date: Dec. 5, 2024

(54) RESILIENTLY IMPACTABLE BOLLARD SYSTEMS

(71) Applicant: Rite-Hite Holding Corporation, Milwaukee, WI (US)

(72) Inventors: Jason T. Dondlinger, Bellevue, IA (US); Tony W. Duesing, Bellevue, IA (US); Nicholas John Casey, Cascade, IA (US); Aaron J. Wiegel, Benton, WI (US)

(21) Appl. No.: 18/680,994

(22) Filed: May 31, 2024

Related U.S. Application Data
(60) Provisional application No. 63/505,317, filed on May 31, 2023.
(60) Provisional application No. 63/597,436, filed on Nov. 9, 2023.

(51) Int. Cl. E01F 9/627

(52) U.S. Cl. CPC E01F 9/629

(57) ABSTRACT

Resiliently impactable bollard systems are disclosed. An example bollard includes a shaft having a flange positioned on an outer surface of the shaft, the flange extending away from the outer surface, a first portion of the shaft extending in a first direction away from the flange and a second portion of the shaft extending in a second direction away from the flange, the second direction different from the first direction, an anchor to be positioned at an end of the shaft, and a first shock absorbing body to be positioned between a first face of the flange and a mounting surface on which the bollard is to be mounted, the first shock absorbing body to contact at least a portion of the first portion of the shaft.

### RELATED APPLICATIONS

This patent claims the benefit of U.S. Provisional Patent Application No. 63/505,317, which was filed on May 31, 2023, and also claims the benefit of U.S. Provisional Patent Application No. 63/597,436, which was filed on Nov. 9, 2023. U.S. Provisional Patent Application No. 63/505,317 and U.S. Provisional Patent Application No. 63/597,436 are incorporated herein by reference in their entireties. Priority to U.S. Provisional Patent Application No. 63/505,317 and U.S. Provisional Patent Application No. 63/597,436 is claimed.

### FIELD OF THE DISCLOSURE

This disclosure relates generally to bollards and, more particularly, to resiliently impactable bollard systems.

### BACKGROUND

Bollards have been developed to absorb impact from vehicles (e.g., manufacturing equipment, cars, etc.). In some instances, a bollard can block (e.g., prevent) passage of such vehicles into a certain area, and thereby prevent impact and potential damage to other things (building structures, goods, equipment, people, etc.). Some bollards may be implemented in parking lots, roads, manufacturing floors, etc.

### BRIEF DESCRIPTION OF THE DRAWINGS

FIG. 1 illustrates an example bollard constructed in accordance with teachings disclosed herein.

FIG. 2 is an exploded view of a first example implementation of the example bollard of FIG. 1.

FIGS. 3-5 are cross-sectional views of the example bollard of FIG. 2.

FIG. 6 is an exploded view of a second example implementation of the example bollard of FIG. 1.

FIG. 7 is a cross-sectional view of the example bollard of FIG. 6.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts. Further, as used herein, stating that any part is directly adjacent to another part is defined to mean that the two elements are not necessarily touching but that they are in close proximity with no intermediate materials positioned therebetween.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

### DETAILED DESCRIPTION

In some industrial environments, bollards may block vehicles or goods from entering or colliding with certain equipment, storage facilities, pedestrian spaces, other vehicles, etc. Many bollards include internal mechanisms for absorbing impact and/or resisting load. In some examples, bollards utilize shock absorbing (e.g., energy absorbing, dampening, etc.) material to resist impacts. Even though such example bollards may be able to slow or stop a moving vehicle upon impact, an impact can cause damage to the bollard or may render the bollard inoperable or less resilient (unable to withstand subsequent impacts). Examples disclosed herein utilize shock absorbing material and design to absorb or resist impact experienced by example bollards. Examples disclosed herein reduce the risk of damage to bollard systems by employing shock absorbing material that can contact a bollard shaft and/or an anchor of the bollard. Examples disclosed herein utilize a shaft with a flange to distribute forces to other load bearing portions of the bollard (e.g., multiple shock absorbing bodies, the anchor, the shaft, etc.).

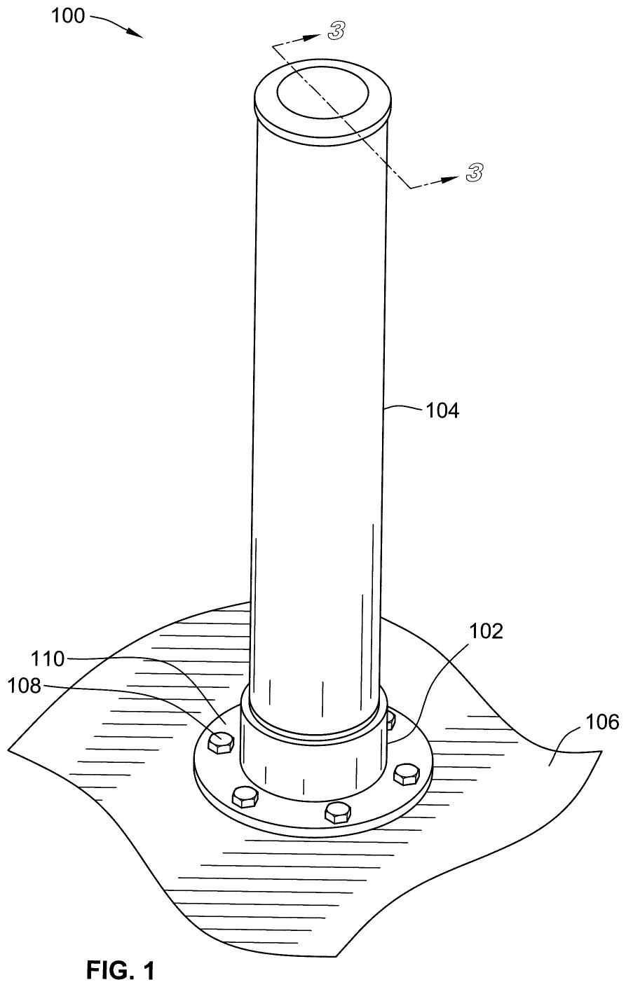

FIG. 1 illustrates an example bollard 100 constructed in accordance with teachings disclosed herein. The example bollard 100 includes an example anchor (e.g., housing, collar, baseplate, etc.) 102 and an example casing (e.g., covering) 104. As shown in FIG. 1, the example anchor 102 is couplable (e.g., mountable) to an example ground (e.g., ground surface, mounting surface, etc.) 106. Further, the example bollard 100 may be secured (e.g., mounted, anchored, etc.) to the ground 106 via screws 108. Additionally or alternatively, the example anchor 102 includes an example mounting flange 110 that may couple to the ground 106.

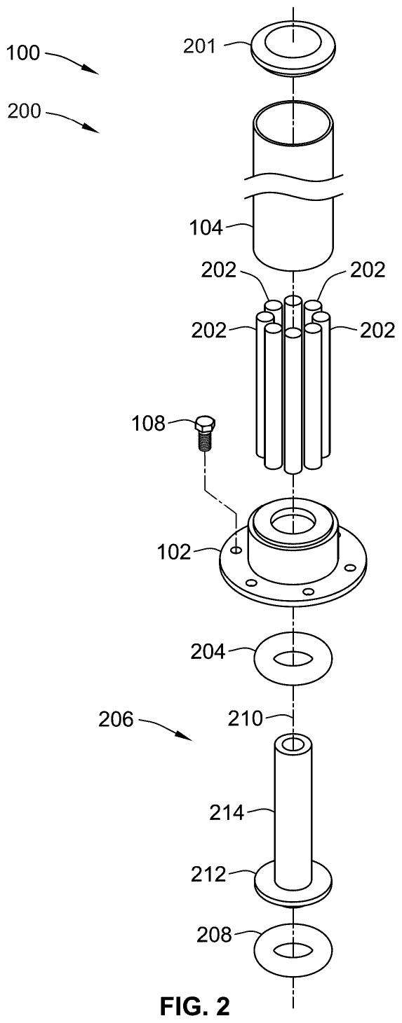

FIG. 2 illustrates an exploded view of a first example implementation 200 of the example bollard 100 of FIG. 1. As shown in FIG. 2, the example bollard 100 further includes an example cap 201, example elongate shock absorbing bodies (e.g., pillars) 202, an example shock absorbing body 204 (e.g., a first shock absorbing body, an upper shock absorbing body, etc.), an example shaft 206, and another example shock absorbing body 208 (e.g., a second shock absorbing body, a lower shock absorbing body, etc.). The example bollard 100 extends along an example axis 210 (e.g., center axis, longitudinal axis, longitudinal direction, etc.). In some examples, a center axis of the bollard casing 104 is generally aligned relative to a center axis of the shaft 206 and/or the axis 210. In some examples, the cap 201 is omitted. In some such examples, a top of the casing 104 is closed off. In some examples, the cap 201 is integrally formed with the casing 104.

The example shaft 206 includes an example flange (e.g., portion) 212 that surrounds an example outer surface (e.g., outer side wall) 214 of the shaft 206. As shown in FIG. 2, the example flange 212 is positioned on the outer surface 214. The example flange 212 extends (e.g., protrudes) away from the shaft 206 in a radial direction from a center axis of the shaft 206 and/or the axis 210. However, the example flange 212 may extend in any direction away from a center axis of the shaft 206, the axis 210, the outer surface 214 of the shaft 206, etc. In other words, the example flange 212 may protrude from the shaft 206 in a direction transverse to an elongate length of the shaft 206. Additionally or alternatively, the example flange 212 may include multiple separate portions. For example, a first portion of the flange 212 can be spaced apart from a second portion of the flange 212 in a direction extending circumferentially around the shaft 206. In such examples, the first portion of the flange 212 can extend in a first direction away from the outer surface 214 and the second portion of the flange 212 can extend in a second direction away from the outer surface 214, the second direction different from the first direction.

In FIG. 2, the example first and second shock absorbing bodies 204, 208 may be coaxially aligned to each other and/or aligned to the axis 210. As shown in FIG. 2, the second shock absorbing body 208 is closer to the bottom of the bollard 100 than the first shock absorbing body 204. Accordingly, for purposes of explanation, the first and second shock absorbing bodies 204, 208 are referred to herein as upper and lower shock absorbing bodies respectively. The example upper and lower shock absorbing bodies 204, 208 may be annular rings (e.g., compressible rings). In some examples, the upper shock absorbing body 204 and/or the lower shock absorbing body 208 may have a generally spherical shape. That is, in some examples, rather than being one continuous ring (as shown), one or both of the upper and lower shock absorbing bodies 204, 208 may be implemented with multiple, discrete balls or spheres arranged to surround (e.g., at least partially surround) the shaft 206, the outer surface 214, the axis 210, etc. In some such examples, the discrete portions of the shock absorbing bodies 204, 208 may have a shape other than a sphere (e.g., cubes, cylinders (similar to the bodies 202), etc.). Additionally or alternatively, the example shock absorbing bodies 204, 208, can include generally circular cross sections. Thus, in some examples, the shock absorbing bodies 204, 208 are doughnut-shaped (e.g., a toroid with a circular cross-section). In other examples, the cross-sectional shape can be different (e.g., a square or rectangular, an oval shape, etc.). In the illustrated example, both the upper and lower shock absorbing bodies 204, 208 have the same size, shape, and design. However, in other examples, the size, shape, and/or design of the upper and lower shock absorbing bodies 204, 208 can differ. In some examples, shock absorbing bodies 204, 208 can include multiple assembled or stacked elements (e.g., rings or doughnuts). These elements can be of the same or different shapes and made of the same or different materials.

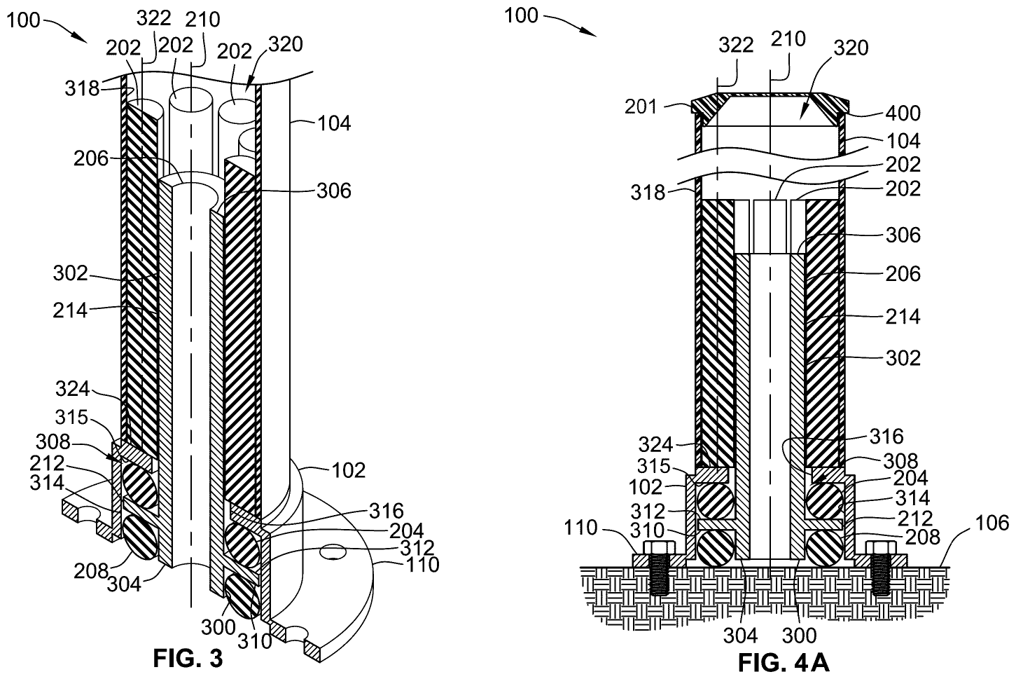

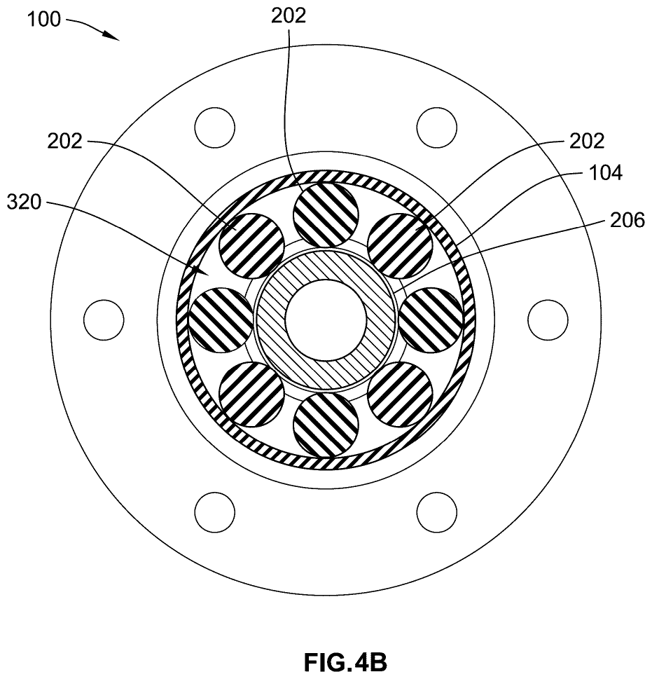

FIGS. 3-4B are cross-sectional views of the example bollard 100. The example shaft 206 includes a first portion 300 that extends in a first direction from the flange 212 to a first end 304 of the shaft and a second portion 302 that extends in a second direction from the flange 212 to a second end 306 of the shaft, the second direction different from the first direction. In this example, the first and second portions 300, 302 extend in a direction generally aligned to the center axis 210 of the shaft 206. In some examples, the first and second portions 300, 302 can extend along direction(s) transverse (e.g., at an angle) to the center axis 210.

The example flange 212 is positioned between the first end 304 of the shaft 206 and the second end 306 of the shaft 206 opposite the first end 304. In this example, the flange 212 is spaced apart from both of the ends 304, 306 of the shaft 206. Further, when the bollard 100 is assembled, the example anchor 102 is positioned at the first end 304 to enclose at least the flange 212, the first portion 300, and the first end 304. In particular, the example mounting flange 110 of the anchor 102 is adjacent to the first end 304 of the shaft 206. That is, in this example, the first portion 300 of the shaft 206 is shorter than the second portion 302 of the shaft 206. The example anchor 102 includes a cavity 308 to receive the flange 212 and the first end 304.

The example flange 212 includes a first surface (e.g., face) 310 that faces towards the first end 304 of the shaft 206 and a second surface (e.g., face) 312 that faces in the opposite direction (e.g., towards the second end 306 of the shaft 206). The example lower shock absorbing body 208 is to be at least partially positioned between the first surface 310 of the flange 212 and the first end 304. Further, the example lower shock absorbing body 208 can be positioned closer to the first end 304 than the flange 212 is to the first end 304 (e.g., adjacent the first portion 300 of the shaft 206). In some examples, the lower shock absorbing body 208 is to be in contact with the first surface 310 of the flange 212 and/or the first portion 300 of the shaft 206. Additionally or alternatively, the lower shock absorbing body 208 is to be positioned within the cavity 308 adjacent (e.g., directly adjacent) the outer surface 214 of the shaft 206. As such, the example lower shock absorbing body 208 can be arranged to at least partially surround (e.g., encircle) the outer surface 214, the first portion 300 of the shaft 206, the first end 304, etc.

In some examples, the lower shock absorbing body 208 is to be positioned between the first surface 310 and the ground 106. In some examples, an entirety of the example lower shock absorbing body 208 is to be closer to the ground 106 than the flange 212 is to the ground 106. As such, the example lower shock absorbing body 208 can separate the flange 212 from the ground 106. In other words, the example flange 212 does not engage with the mounting surface when the bollard 100 is mounted to the mounting surface (e.g., the ground 106). Further, in some examples, the lower shock absorbing body 208 has a thickness that is greater than a length of the first portion 300 of the shaft 206. As such, as mostly clearly shown in FIG. 4A, the lower shock absorbing body 208 extends beyond the first end 304 of the shaft 206 when the lower shock absorbing body 208 is in contact with first surface 310 of the flange 212.

In this example, example outer surfaces of the shock absorbing bodies 204, 208 contact an example side wall (e.g., inner wall, side surface, vertical side wall, inner surface, etc.) 314 of the anchor 102. The example upper shock absorbing body 204 is positioned between the second surface 312 of the flange 212 and the side wall 314 of the anchor 102. Additionally, the example upper shock absorbing body 204 contacts an upper surface 315 of the anchor 102 and the second surface 312 of the flange 212. As such, the upper shock absorbing body 204 separates the second surface 312 of the flange 212 from the upper surface 315 of the anchor 102. Further, the example upper shock absorbing body 204 can be positioned adjacent the outer surface 214 of the shaft 206 (e.g., along the second portion 306 of the shaft 206). The example flange 212 can be positioned between (e.g., separate) the upper shock absorbing body 204 and the lower shock absorbing body 208. Accordingly, in this example, the upper shock absorbing body 204 is entirely above (e.g., higher than, entirely separate from, etc.) the lower shock absorbing body 208. For example, a lowermost portion of the upper shock absorbing body 204 is entirely above an uppermost portion of the lower shock absorbing body 208.

The example anchor 102 encloses the first portion 300 of the shaft 206, the flange 212, the upper shock absorbing body 204, and the lower shock absorbing body 208. Additionally, the example anchor 102 includes an opening 316 to enable the second portion 302 of the shaft, including the second end 306, to protrude (e.g., extend) from the anchor 102. For example, the second portion 302 of the shaft 206 extends away from the anchor 102 along a longitudinal direction (e.g., the center axis 210) of the shaft 206. In some examples, the shaft 206 can extend any suitable distance above the anchor 102 (e.g., halfway up the height of the casing 104, less than halfway up the height of the casing 104, more than halfway the height of the casing 104, etc.).

In this example, a diameter (e.g., size) of the flange 212 is greater than a diameter of the opening 316. Accordingly, the size of the flange 212 prevents the flange 212 from fitting through the opening 316 during assembly and/or operation. The example upper shock absorbing body 204 may be positioned on the upper surface 312 of the flange 212 prior to positioning (e.g., feeding) the shaft 206 through the opening 316. As such, the example upper shock absorbing body 204 can be sandwiched between the upper surface 315 and the flange 212. Then, the example lower shock absorbing body 208 can be added to the example assembly. However, the example lower shock absorbing body 208 may be added to the assembly at any time prior to securing the bollard 100 to the ground 106.

The example casing 104 at least partially encloses (e.g., encloses, fully encloses, covers, etc.) the second portion 302 of the shaft 206. The outer surface 214 of the shaft 206 can be spaced apart from an example inner surface 318 of the casing 104 to define an example chamber 320 therebetween when the casing 104 surrounds the shaft 206.

Further, the example bollard 100 includes at least one of the elongate shock absorbing bodies 202 that separates (e.g., is positioned between) the second portion 302 of the shaft 206 and the inner surface 318 of the casing 104. For example, the elongate shock absorbing bodies 202 can fill at least a portion of the chamber 320 between the shaft 206 and the casing 104. In this example, the elongate shock absorbing bodies 202 are positioned to surround a perimeter (e.g., the outer surface 214) of the shaft 206. The example elongate shock absorbing bodies 202 may include longitudinal axes (e.g., an example longitudinal axis 322) that are offset (e.g., laterally offset, not coaxially aligned, etc.) from the center axis 210 of the shaft 206. For example, the elongate shock absorbing bodies 202 can be approximately parallel (e.g., within 5 degrees) and radially spaced with respect to the shaft 206. To that end, the example elongate shock absorbing bodies 202 may extend along an elongate length (e.g., a longitudinal direction) of the shaft 206. For example, at least one of the elongate shock absorbing bodies 202 can extend from an exterior surface (e.g., outer surface) 324 of the anchor 102 to the second end 306 of the shaft 206. In this example, the exterior surface 324 is adjacent to the opening 316. In some examples, at least one of the elongate shock absorbing bodies 202 can extend from the anchor 102 to an example end 400 of the casing 104 and/or the cap 201 of the casing 104. In some examples, the elongate shock absorbing bodies 202 can extend any suitable distance above the anchor 102 (e.g., halfway up the height of the casing 104, less than halfway up the height of the casing 104, more than halfway the height of the casing 104, etc.).

In this example, the elongate shock absorbing bodies 202 extend beyond the second end 306 of the shaft 206. However, the example elongate shock absorbing bodies 202 may not extend beyond the second end 306 of the shaft 206. In some examples, the second end 306 of the shaft 206 extends beyond the elongate shock absorbing bodies 202. In an example upright orientation of the example bollard 100, the length of one of the elongate shock absorbing bodies 202 can be longer than the length of the second portion 302 of the shaft 206. Additionally, the example elongate shock absorbing bodies 202 have a cylindrical shape and, thus, a generally circular cross-section. In other examples, the elongate shock absorbing bodies 202 may have a prismatic shape, a square shape, a rectangular shape, or any other suitable shape or cross-section. In FIGS. 3-4B, the example elongate shock absorbing bodies 202 are smaller in diameter than the diameter of the shaft 206. In some examples, the elongate shock absorbing bodies 202 may be larger in diameter than the diameter of the shaft 206. In some examples, the elongate shock absorbing bodies 202 are integrally formed to define a sleeve that extends continuously around the shaft 206.

FIG. 4B is a cross-sectional top view of the example bollard 100. As shown in FIG. 4B, the example elongate shock absorbing bodies 202 are positioned to surround the shaft 206. The example casing 104 encircles the elongate shock absorbing bodies 202. In FIG. 4B, the example chamber 320 is at least partially filled with the elongate shock absorbing bodies 202 such that the elongate shock absorbing bodies 202 are spaced apart. In some such examples, spacers (not shown) may be used to maintain the separation between adjacent elongate shock absorbing bodies 202 and/or assist in assembly or installation of the bollard 100. In some examples, the elongate shock absorbing bodies 202 may not be spaced apart. In such examples, the chamber 320 may be filled (e.g., packed, fully filled, etc.) by elongate shock absorbing bodies 202. For example, adjacent ones of the elongate shock absorbing bodies 202 may be in contact with (e.g., abutting) one another.

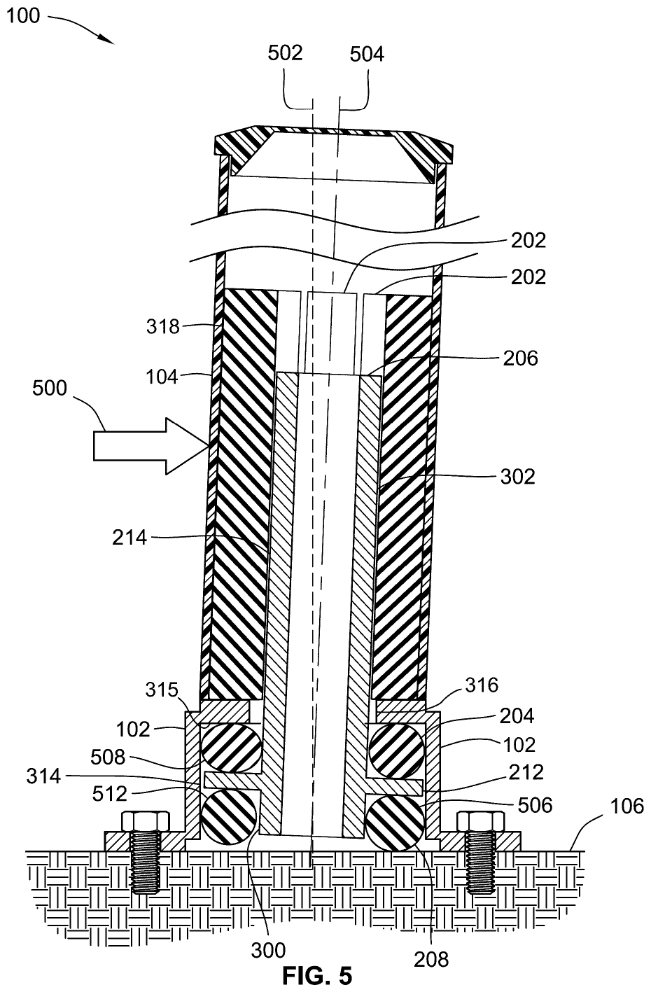

FIG. 5 illustrates a cross-sectional view of the example bollard 100. In this example, the bollard 100 is shown to be under impact, force, load, etc., along a direction as generally shown by an example force vector 500. The example the force impacting the bollard 100 causes a displacement of the example bollard 100. For example, prior to impact the example bollard 100 may have been generally aligned to a first example axis (e.g., upright axis) 502. After impact and/or during impact, the example bollard 100 is moved (e.g., leaned, titled, angled, shifted, etc.) to a second example axis (e.g., displaced axis) 504. In the example of FIG. 5, the elongate shock absorbing bodies 202 are approximately parallel to the axis 504 and the second portion 302 of the shaft 206. However, during operation the example elongate shock absorbing bodies 202 may be moved to different positions and/or angles relative to each other and/or the shaft 206.

The design and construction of the example bollard 100 provide several mechanisms to absorb impacts of various severities represented by the force vector 500. The elongate shock absorbing bodies 202 serve as the initial point of contact with an impact to the casing 104 and, therefore, the initial shock absorbing mechanism of the bollard 100. That is, for relatively small impact forces, the elongate shock absorbing bodies 202 may be able to deform (e.g., compress) to absorb the impact without significantly affecting the rest of the assembly. The example elongate shock absorbing bodies 202 may be made of compressible materials (e.g., natural rubber, polyurethane, polyethylene foam, closed cell foams, etc.) to enable such compression, deformation, resiliency, etc. In some examples, an outer surface of a first one of the elongate shock absorbing bodies 202 may engage with (be urged against) an outer surface of a second one of the elongate shock absorbing bodies 202 during an impact with the bollard 100. In such examples, the second one of the elongate shock absorbing bodies 202 supports and/or cushions movement of the first one of the elongate shock absorbing bodies 202. Further, the elongate shock absorbing bodies 202 are positioned to cushion the shaft 206 from contacting the casing 104. In some examples, the elongate shock absorbing bodies 202 engage with (e.g., contact) the outer surface 214 of the shaft 206 to resist and/or dampen movement of the shaft 206.

In some examples, the elongate shock absorbing bodies 202 may include materials that have a relatively high coefficient of friction such that adjacent ones of the elongate shock absorbing bodies 202 can grip (e.g., attach, adhere, stick, etc.) to one another and/or the casing 104. For example, an outer surface of at least one of the elongate shock absorbing bodies 202 can adhere to the inner surface 318 of the casing 104. The example outer surface of the at least one of the elongate shock absorbing bodies 202 resists movement of the casing 104 based on the friction between the outer surface of the at least one of the elongate shock absorbing bodies 202 and the inner surface 318. That is, during an impact the example casing 104 not only moves sideways but may also be urged upward (e.g., away from the anchor 102.) However, the relatively high friction surfaces of the elongate shock absorbing bodies 202 can reduce (e.g., eliminate) vertical movement of the casing 104.

In other examples, an outer surface of a first one of the elongate shock absorbing bodies 202 can adhere to an outer surface of a second one of the elongate shock absorbing bodies 202. The example outer surface of the second one of the elongate shock absorbing bodies 202 resists vertical movement of the first one of the elongate shock absorbing bodies 202 based on the friction between the outer surfaces of the first and second elongate shock absorbing bodies 202. As such, the elongate shock absorbing bodies 202 may engage with one another to distribute (e.g., counteract) force experienced by the shaft 206 and/or the bollard 100.

If the impact force is great enough, the force may be transferred through the elongate shock absorbing bodies 202 to the shaft 206. Such a force can cause the shaft 206 to shift or tilt as shown in FIG. 5. In this example, a size (e.g., diameter, width, etc.) of the flange 212 is less than a size of the cavity 308. As such, there may be a gap and/or clearance between the flange 212 and the side wall 314 to permit the shaft 216 to tilt. In some examples, the flange 212 may contact the side wall 314 of the anchor 102 such that the anchor 102 absorbs at least some of the impact force. However, as shown in FIG. 5, the tilting of the shaft 206 can result in the shaft 206 and/or the flange 212 (tilting with the shaft 206) being pressed or urged against the shock absorbing bodies 204, 208 within the anchor 102. In this example, the shaft 206 may be made of a material that is harder (e.g., more stiff, less compressible or deformable, etc.) than the elongate shock absorbing bodies 202. For example, the shaft 206 may be a steel shaft that can tilt, causing deformation of the elongate shock absorbing bodies 202, in response to force.

Similar to the example elongate shock absorbing bodies 202, the shock absorbing bodies 204, 208 may be made from a compressible material (e.g., natural rubber, polyurethane, polyethylene foam, closed cell foams, etc.) that can deform under force. In some examples, the upper and lower shock absorbing bodies 204, 208 are made of the same material as the elongate shock absorbing bodies 202. In other examples, the upper and lower shock absorbing bodies 204, 208 are made of a different material from the elongate shock absorbing bodies 202. That is, in some examples, the upper and lower shock absorbing bodies 204, 208 are stiffer than the elongate shock absorbing bodies 202. In other examples, the elongate shock absorbing bodies 202 are stiffer than the upper and lower shock absorbing bodies 204, 208. In some examples, the upper shock absorbing body 204 is made of a different material (e.g., has a different stiffness) from the lower shock absorbing body 208. Generally speaking, the example shock absorbing bodies 204, 208 are resiliently compressible or deformable but firm to support (e.g., hold, stabilize) the shaft 206 prior to and/or during impact. For example, at least the lower shock absorbing body 208 can compress when the bollard 100 is assembled such that the lower shock absorbing body 208 supports the weight of shaft 206. The example lower shock absorbing body 208 may extend beyond the first end 304 prior to assembly. Then, when the shaft 206 and the lower shock absorbing body 208 are assembled within the anchor 102, and the anchor 102 is secured to the ground 106, the lower shock absorbing body 208 is compressed (e.g., squeezed) between the flange 212 and the ground 106. The example lower shock absorbing body 208 can maintain clearance (e.g., space, gap, etc.) between the first end 304 and the ground 106. Additionally or alternatively, the example lower shock absorbing body 208 can maintain clearance between the flange 212 and the ground 106 prior to and/or during operation. Further, the example upper shock absorbing body 204 may be compressed when the anchor 102 is secured to the ground 106. As such, the example upper shock absorbing body 204 may be compressed between the anchor 102 and the flange 212.

The shock absorbing bodies 204, 208 are positioned to counteract (e.g., cushion, absorb, etc.) an impact on the bollard 100. That is, as shown in FIG. 5, an example first portion 506 of the lower shock absorbing body 208 resists a generally downward motion (e.g., force) of the flange 212 as the shaft 206 tips. Accordingly, the example first portion 506 of the lower shock absorbing body 208 can prevent the flange 212 from contacting the ground 106 during operation. Further, an example first portion 508 of the upper shock absorbing body 204 resists a generally upward motion of the flange 212 as the shaft 206 tips. Accordingly, the example first portion 508 of the upper shock absorbing body 204 can prevent the flange 212 from contacting the upper surface 315 of the anchor 102 and/or the side wall 314. In some examples, an example second portion 512 of the lower shock absorbing body 208 resists a generally lateral and/or rotational motion of the first portion 300 of the shaft 206. For example, the second portion 512 of the lower shock absorbing body 208 can prevent the first portion 300 from contacting the side wall 314 of the anchor 102.

As shown in FIG. 5, a diameter of the shaft 206 is less than a diameter of the opening 316. For relatively small impacts, the clearance between the shaft 206 and the opening 316 permits the shaft 206 to tilt without necessarily contacting the anchor 102. However, for relatively large impacts, the forces involved may overcome the reactionary forces from both the elongate shock absorbing bodies 202 and the shock absorbing bodies 204, 208 within the anchor 102 as described above. In such situations, the shaft 206 will be urged even further than shown in FIG. 5 until the outer surface 214 of the shaft 206 comes into contact with the rim of the opening 316 in the anchor 102. As a result, the force of impact will transfer directly from the rigid shaft 206 to the rigid anchor 102. However, in many instances, a significant portion of the impact will have already been absorbed by the elongate shock absorbing bodies 202 and the shock absorbing bodies 204, 208, thereby reducing the likelihood of any significant damage to the bollard 100 (or the object impacting the bollard 100).

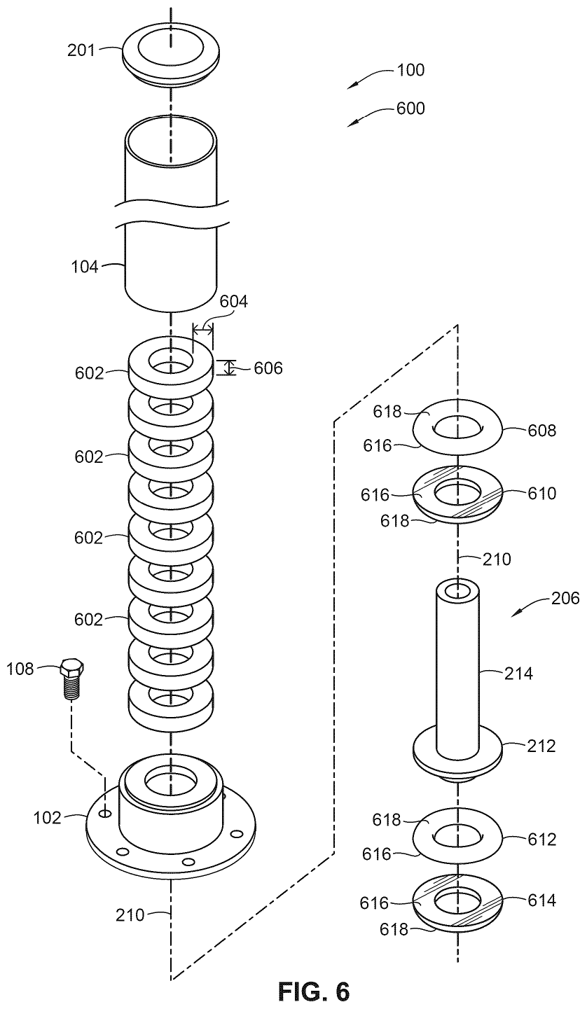

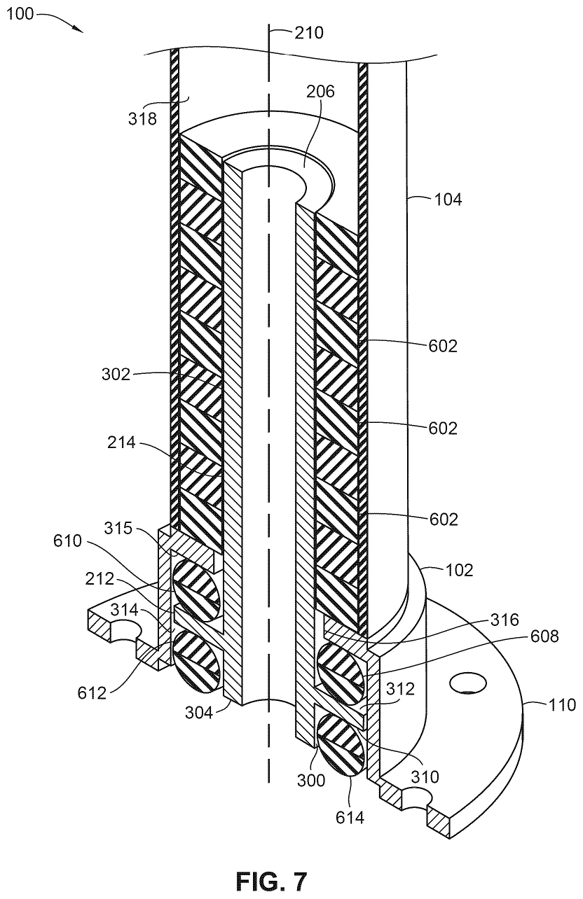

FIG. 6 is an exploded view of a second example implementation 600 of the example bollard 100 of FIG. 1. FIG. 7 is a cross-sectional view of the example bollard 100 of FIG. 6. The second example implementation 600 of FIGS. 6 and 7 is similar to the first example implementation 200 of FIGS. 2-5. The same reference numerals used in FIGS. 1-5 are used in FIGS. 6 and 7 for the same or similar components. Further, the discussion of such components provided above in connection with FIGS. 1-5 applies equally to the corresponding components shown in FIGS. 6 and 7.

The second example implementation 600 of the example bollard 100 shown in FIGS. 6 and 7 differs from the first example implementation 200 of FIGS. 2-5 in that the elongate shock absorbing bodies (e.g., pillars) 202 are omitted. Instead, in the illustrated example of FIGS. 6 and 7, a plurality of annular shock absorbing bodies 602 surround the second portion 302 of the shaft 206. In other examples, one or more of the annular shock absorbing bodies 602 can be replaced by a number of spherical or prismatic shaped bodies. Thus, the shock absorbing bodies 602 are positioned in the space between the inner surface 318 of the casing 104 and the second portion 302 of the shaft 206. Similar to the example elongate shock absorbing bodies 202 and the shock absorbing bodies 204, 208 discussed above in connection with FIGS. 2-5, the annular shock absorbing bodies 602 of FIGS. 6 and 7 may be made from a compressible material (e.g., natural rubber, polyurethane, polyethylene foam, closed cell foams, etc.) that can resiliently deform under force.

In this example, there are nine annular shock absorbing bodies 602. However, in other examples, any other number of annular shock absorbing bodies 602 may be employed. The particular number used depends on the total axial distance of the annular shock absorbing bodies 602 when stacked together and the size of each one of the annular shock absorbing bodies 602. In some examples, the annular shock absorbing bodies 602 are in the shape of a toroid with a rectangular cross-section. In other examples, the annular shock absorbing bodies 602 can have a different cross-sectional shape (e.g., circular, oval, trapezoidal, irregular, etc.). In some examples, a radial width 604 of the cross-section is greater than an axial thickness 606 of the cross-section. In some examples, the radial width 604 is equal to the axial thickness 606 (e.g., the cross-section is square). In some examples, the axial thickness 606 is greater than the radial width 604 of the cross-section. In some such examples, the axial thickness 606 can be many times greater than the radial thickness 604. That is, in some examples, the annular shock absorbing bodies 602 have a tubular shape. In some examples, a single shock absorbing body 602 with a tubular shape can be used with an axial thickness 606 (e.g., a tubular length) corresponding to the total axial distance of the stack of annular shock absorbing bodies 602 shown in FIG. 7. That is, in some examples, the bollard 100 includes only one annular shock absorbing body 602. However, in some examples, implementing multiple smaller annular shock absorbing bodies 602 can facilitate the assembly of the bollard 100. In this example, each of the annular shock absorbing bodies 602 are the same size. However, in other examples, different ones of the annular shock absorbing bodies 602 can be different sizes. In some examples, both annular and elongated shock absorbing bodies can be used (positioned within the cavity).

As shown in FIG. 7, the total axial distance of the annular shock absorbing bodies 602 when stacked together is sufficient to extend along the entire length of the second portion 302 of the shaft 206 exposed through the anchor 102. More particularly, in this example, the stack of annular shock absorbing bodies 602 extends slightly beyond the top of the shaft 206. In other examples, the stack of annular shock absorbing bodies 602 can extend farther beyond the top of the shaft 206 than what is shown in FIG. 7. In some examples, additional annular shock absorbing bodies 602 are stacked that are completely above the top of the shaft 206. That is, in some examples, the stack of annular shock absorbing bodies 602 extends beyond the top of the shaft 206 by more than the axial thickness 606 of ones of the annular shock absorbing bodies 602. In other examples, the top of the shaft 206 extends beyond the stack of annular shock absorbing bodies 602.

The second example implementation 600 of the example bollard 100 shown in FIGS. 6 and 7 also differs from the first example implementation 200 of FIGS. 2-5 in the shape of the shock absorbing bodies positioned within the anchor 102. Unlike the example shown in FIG. 205 in which a single shock absorbing body 204 is positioned above the flange 212 and a single shock absorbing body 208 is positioned below the flange 212, in the illustrated example of FIGS. 6 and 7, two shock absorbing bodies 608, 610 are positioned above the flange 212 and two shock absorbing bodies 612, 614 are positioned below the flange 212. In this example, each of the shock absorbing bodies 608, 610, 612, 614 within the anchor has a toroid shape with a semi-circular cross-section. That is, the shock absorbing bodies 608, 610, 612, 614 are bagel-shaped with flat surfaces 616 facing towards one another and rounded surfaces facing away from one another. In this example, the combined shape of the two shock absorbing bodies 608, 610 above the flange is similar to the shock absorbing body 204 shown in FIGS. 2-5. Likewise, the combined shape of the two shock absorbing bodies 612, 614 below the flange is similar to the shock absorbing body 208 shown in FIGS. 2-5. Although the sock absorbing bodies 608, 610, 612, 614 are shown and described as having a semi-circular cross-section, other shapes are possible. For instance, in some examples, the round portion of the semi-circular cross-section to define a relatively small flat annular surface opposite the larger flat surface 616 shown in the illustrated examples. In other examples, the shock absorbing bodies 608, 610, 612, 614 can have a differently shaped (e.g., trapezoidal, irregular, rectangular, etc.) cross-section. In some examples, more than two shock absorbing bodies 608, 610, 612, 614 can be positioned above and/or below the flange 212.

Although FIGS. 2-5 and FIGS. 6 and 7 are described as two separate implementations of the example bollard 100 of FIG. 1, the disclosed features in FIGS. 2-5 can be combined in any suitable manner with the disclosed features of FIGS. 6 and 7. For instance, in some examples, the annular shock absorbing bodies 602 of FIGS. 6 and 7 can be used in combination with the shock absorbing bodies 204, 208 of FIGS. 2-5. In some examples, the shock absorbing bodies 608, 610, 612, 614 can be used in combination with the elongate shock absorbing bodies 202 of FIGS. 2-5. In some examples, the annular shock absorbing bodies 602 of FIGS. 6 and 7 can be used along part of the second portion 302 of the shaft 206 with the elongate shock absorbing the example of FIGS. 2-5 used along a different part of the second portion 302 of the shaft 206. In some examples, the two shock absorbing bodies 608, 610, 612, 614 of FIGS. 6 and 7 can be used either above or below the flange 212 with one of the single shock absorbing bodies 204, 208 used on the other side of the flange 212.

In short, the foregoing examples implementations 200, 600 of the bollard 100 teach or suggest different features. Although each example implementation 200, 600 disclosed above has certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example's features are not mutually exclusive to another example's features. Instead, the scope of this disclosure encompasses any combination of any of the features.

From the foregoing, it will be appreciated that example systems, apparatus, articles of manufacture, and methods have been disclosed that utilize shock absorbing material to resist impacts experienced by example bollards. Examples disclosed herein reduce the risk of damage to bollard systems by employing shock absorbing material that can contact a bollard shaft and/or an anchor of the bollard. Examples disclosed herein utilize a shaft flange to distribute forces to other load bearing portions of the bollard.

Further examples and combinations thereof include the following:
Example 1 includes a bollard comprising a shaft having a flange positioned on an outer surface of the shaft, the flange extending away from the outer surface, a first portion of the shaft extending in a first direction away from the flange and a second portion of the shaft extending in a second direction away from the flange, the second direction different from the first direction, an anchor to be positioned at an end of the shaft, and a first shock absorbing body to be positioned between a first face of the flange and a mounting surface on which the bollard is to be mounted, the first shock absorbing body to contact at least a portion of the first portion of the shaft.
Example 2 includes the bollard of example 1, wherein the first shock absorbing body is to at least partially surround the outer surface of the shaft.
Example 3 includes the bollard of any one of examples 1 or 2, where the first shock absorbing body is to be at least partially positioned between the first face of the flange and the end of the shaft.
Example 4 includes the bollard of any one of examples 1-3, further including multiple ones of the first shock absorbing body arranged to surround the shaft.
Example 5 includes the bollard of any one of examples 1-4, wherein the flange extends away from the shaft in a radial direction from a center axis of the shaft.
Example 6 includes the bollard of any one of examples 1-5, wherein the flange surrounds the outer surface of the shaft.
Example 7 includes the bollard of any one of examples 1-6, wherein the flange does not engage with the mounting surface when the bollard is mounted to the mounting surface.
Example 8 includes the bollard of any one of examples 1-7, wherein the first shock absorbing body is a compressible ring.
Example 9 includes the bollard of example 8, further including a second shock absorbing body, the second shock absorbing body to be positioned between the first shock absorbing body and the first face of the flange.
Example 10 includes the bollard of example 9, wherein the first shock absorbing body has a first flat surface and a first rounded surface opposite the first flat surface, and the second shock absorbing body has a second flat surface and a second rounded surface opposite the second flat surface, the first flat surface to abut the second flat surface.
Example 11 includes the bollard of any one of examples 1-10, further including a second shock absorbing body, the second shock absorbing body to be positioned between a second face of the flange opposite the first face and a surface of the anchor.
Example 12 includes the bollard of example 11, wherein the flange is to be positioned between the first shock absorbing body and the second shock absorbing body.
Example 13 includes the bollard of any one of examples 11 or 12, wherein outer surfaces of the first and second shock absorbing bodies are to contact a side wall of the anchor.
Example 14 includes the bollard of any one of examples 11-13, wherein at least one of the first shock absorbing body or the second shock absorbing body is an annular ring.
Example 15 includes the bollard of any one of examples 11-14, wherein the at least one of the first shock absorbing body or the second shock absorbing body is coaxially aligned with a longitudinal axis of the shaft.
Example 16 includes the bollard of any one of examples 1-15, further including a bollard casing to at least partially enclose the second portion of the shaft.
Example 17 includes the bollard of example 16, wherein a center axis of the bollard casing is generally aligned relative to a center axis of the shaft.
Example 18 includes the bollard of any one of examples 16 or 17, further including a second shock absorbing body to be positioned between the shaft and the bollard casing.
Example 19 includes the bollard of example 18, wherein a longitudinal axis of the second shock absorbing body is to be offset from a center axis of the shaft.
Example 20 includes the bollard casing of any one of examples 18 or 19, further including multiple ones of the second shock absorbing body to be positioned to surround a perimeter of the shaft.
Example 21 includes the bollard casing of example 20, wherein the multiple ones of the second shock absorbing body have a generally circular cross-sectional shape.
Example 22 includes the bollard casing of any one of examples 20 or 21, wherein an outer surface of a first one of the multiple ones of the second shock absorbing body is to engage with an outer surface of a second one of the multiple ones of the second shock absorbing body.
Example 23 includes the bollard of any one of examples 16-22, further including a plurality of annular shock absorbing bodies to be positioned around the second portion of the shaft within the bollard casing.
Example 24 includes the bollard of example 23, wherein a first one of the plurality of annular shock absorbing bodies is a toroid with a rectangular cross-section.
Example 25 includes an apparatus comprising a shaft having a first end and a second end opposite the first end, a flange protruding from the shaft, the flange including a first surface and a second surface opposite the first surface, a first shock absorbing body to be positioned directly adjacent an outer side wall of the shaft, the first shock absorbing body to be in contact with the first surface of the flange, a second shock absorbing body to be positioned directly adjacent the outer side wall of the shaft, the second shock absorbing body to be in contact with the second surface of the flange, and a housing to enclose the first and second shock absorbing bodies.
Example 26 includes the apparatus of example 25, wherein the first shock absorbing body is arranged to at least partially surround the outer side wall of the shaft.
Example 27 includes the apparatus of any one of examples 25 or 26, wherein the housing is to anchor to a ground surface.
Example 28 includes the apparatus of example 27, wherein the first shock absorbing body is to separate the flange and the ground surface.
Example 29 includes the apparatus of any one of examples 25-28, wherein a portion of the shaft is to extend away from the housing along a longitudinal direction of the shaft.
Example 30 includes the apparatus of example 29, further including a covering to enclose the portion of the shaft.
Example 31 includes the apparatus of example 30, further including a third shock absorbing body separating the portion of the shaft and an inner wall of the covering.
Example 32 includes the apparatus of example 31, wherein the third shock absorbing body extends from an outer surface of the housing to the second end of the shaft, the third shock absorbing body to extend along the longitudinal direction.
Example 33 includes the apparatus of any one of examples 31 or 32, wherein the third shock absorbing body is to surround the shaft.
Example 34 includes the apparatus of example 33, wherein the third shock absorbing body is one of a plurality of annular shock absorbing bodies, the plurality of annular shock absorbing bodies to be stacked within the covering along a length of the shaft.
Example 35 includes the apparatus of any one of examples 25-34, further including a third shock absorbing body to be positioned directly adjacent the first shock absorbing body, the first shock absorbing body between the third shock absorbing body and the first surface of the flange.
Example 36 includes a bollard comprising a bollard shaft having a first end and a second end opposite the first end, the shaft including a flange positioned between and spaced apart from the first and second ends of the shaft, the flange protruding from the shaft in a direction transverse to an elongate length of the shaft, a collar to enclose a first portion of the shaft including the flange and the first end, the collar having a cavity to receive the flange and the first end of the shaft and an opening to enable a second portion of the shaft, including the second end, to protrude from the collar, and a shock absorbing body to be positioned within the cavity adjacent the shaft, the shock absorbing body to be closer to the first end of the shaft than the flange is to the first end of the shaft.
Example 37 includes the bollard of example 36, wherein the shock absorbing body is positioned to encircle the first end of the shaft.
Example 38 includes the bollard of any one of examples 36 or 37, wherein the collar includes a mounting flange to be adjacent the first end of the shaft, the mounting flange couplable to a ground surface.
Example 39 includes the bollard of any one of examples 36-38, further including a bollard casing to surround the second portion of the shaft protruding from the collar, an inner surface of the bollard casing and an outer surface of the shaft spaced apart to define a chamber therebetween when the bollard casing surrounds the shaft.
Example 40 includes the bollard of example 39, further including a shock absorbing pillar to fill at least a portion of the chamber between the shaft and the bollard casing.
Example 41 includes the bollard of example 40, wherein the shock absorbing pillar is to extend from the collar towards an end of the bollard casing.
Example 42 includes the bollard of any one of examples 36-41, wherein the shock absorbing body is a first shock absorbing body, the bollard further including a plurality of annular shock absorbing bodies, the plurality of annular shock absorbing bodies to surround second portion of the shaft.
Example 43 includes the bollard of any one of examples 36-42, wherein the shock absorbing body is a first shock absorbing body, the bollard further including a second shock absorbing body, the second shock absorbing body to be closer to the first end of the shaft than the first shock absorbing body is to the first end of the shaft.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

1. A bollard comprising:
a shaft having a flange positioned on an outer surface of the shaft, the flange extending away from the outer surface, a first portion of the shaft extending in a first direction away from the flange and a second portion of the shaft extending in a second direction away from the flange, the second direction different from the first direction;
an anchor to be positioned at an end of the shaft; and
a first shock absorbing body to be positioned between a first face of the flange and a mounting surface on which the bollard is to be mounted, the first shock absorbing body to contact at least a portion of the first portion of the shaft.

2. The bollard of claim 1, wherein the first shock absorbing body is to at least partially surround the outer surface of the shaft.

3. The bollard of claim 1, where the first shock absorbing body is to be at least partially positioned between the first face of the flange and the end of the shaft.

4-7. (canceled)

8. The bollard of claim 1, wherein the first shock absorbing body is a compressible ring.

9. The bollard of claim 8, further including a second shock absorbing body, the second shock absorbing body to be positioned between the first shock absorbing body and the first face of the flange.

10. (canceled)

11. The bollard of claim 1, further including a second shock absorbing body, the second shock absorbing body to be positioned between a second face of the flange opposite the first face and a surface of the anchor.

12. The bollard of claim 11, wherein the flange is to be positioned between the first shock absorbing body and the second shock absorbing body.

13. The bollard of claim 11, wherein outer surfaces of the first and second shock absorbing bodies are to contact a side wall of the anchor.

14. The bollard of claim 11, wherein at least one of the first shock absorbing body or the second shock absorbing body is an annular ring.

15. The bollard of claim 11, wherein the at least one of the first shock absorbing body or the second shock absorbing body is coaxially aligned with a longitudinal axis of the shaft.

16. The bollard of claim 1, further including a bollard casing to at least partially enclose the second portion of the shaft.

17. (canceled)

18. The bollard of claim 16, further including a second shock absorbing body to be positioned between the shaft and the bollard casing.

19. The bollard of claim 18, wherein a longitudinal axis of the second shock absorbing body is to be offset from a center axis of the shaft.

20. The bollard casing of claim 18, further including multiple ones of the second shock absorbing body to be positioned to surround a perimeter of the shaft.

21. (canceled)

22. The bollard casing of claim 20, wherein an outer surface of a first one of the multiple ones of the second shock absorbing body is to engage with an outer surface of a second one of the multiple ones of the second shock absorbing body.

23. The bollard of claim 16, further including a plurality of annular shock absorbing bodies to be positioned around the second portion of the shaft within the bollard casing.

24. (canceled)

25. An apparatus comprising:
a shaft having a first end and a second end opposite the first end;
a flange protruding from the shaft, the flange including a first surface and a second surface opposite the first surface;
a first shock absorbing body to be positioned directly adjacent an outer side wall of the shaft, the first shock absorbing body to be in contact with the first surface of the flange;
a second shock absorbing body to be positioned directly adjacent the outer side wall of the shaft, the second shock absorbing body to be in contact with the second surface of the flange; and
a housing to enclose the first and second shock absorbing bodies.

26. (canceled)

27. The apparatus of claim 25, wherein the housing is to anchor to a ground surface.

28-35. (canceled)

36. A bollard comprising:
a bollard shaft having a first end and a second end opposite the first end, the shaft including a flange positioned between and spaced apart from the first and second ends of the shaft, the flange protruding from the shaft in a direction transverse to an elongate length of the shaft;
a collar to enclose a first portion of the shaft including the flange and the first end, the collar having a cavity to receive the flange and the first end of the shaft and an opening to enable a second portion of the shaft, including the second end, to protrude from the collar; and
a shock absorbing body to be positioned within the cavity adjacent the shaft, the shock absorbing body to be closer to the first end of the shaft than the flange is to the first end of the shaft.

37. (canceled)

38. The bollard of claim 36, wherein the collar includes a mounting flange to be adjacent the first end of the shaft, the mounting flange couplable to a ground surface.

39-43. (canceled)
